(19) United States
(12) Patent Application Publication
(10) Pub. No.: US 2004/0229488 A1
(43) Pub. Date: Nov. 18, 2004

(54) Selectable receptacle

(76) Inventors: Donald E. DeWitt, Syracuse, IN (US); Phillip A. McCoy, Albion, IN (US)

Correspondence Address: Todd T. Taylor, TAYLOR & AUST, P.C., 142 S. Main St., P.O. Box 560, Avilla, IN, 46710, US

(21) Appl. No.: 10/438,139

(22) Filed: May 14, 2003

(51) Int. Cl. H01R 24/00

(52) U.S. Cl. 439/201

(57) ABSTRACT

A modular electrical receptacle including a housing, a faceplate being either integral with or attached to the housing, the faceplate having at least two blade openings. The receptacle also including a plurality of line conductors disposed at least partially within the housing, at least one neutral conductor positioned in the housing, at least one neutral conductor having a socket located proximate to at least one of the two blade openings and at least one selector switch electrically connected to at least one of the plurality of line conductors.

### BACKGROUND OF THE INVENTION

1. Field of the Invention

The present invention relates to an electrical outlet receptacle, and, more particularly, to a modular electrical outlet receptacle.

2. Description of the Related Art

Modular outlet receptacles may be included in modular office partitions and they provide flexibility in terms of system layout and interconnectability to other components of the electrical system. Typically, such a modular electrical receptacle includes at least one connector, which is adapted to interface with a corresponding connector or wiring harness. A wiring harness typically includes electrical connectors at opposing ends thereof, which extend to another component of the electrical system such as another electrical receptacle. The connector of the electrical receptacle also includes contacts, which are electrically connected to each of line, neutral and ground conductors disposed within the modular electrical receptacle.

A problem with known modular electrical receptacles is that they must be configured before assembly or disassembled in order to be reconfigured. A typical configuration process includes selecting conductors and inserting them within the electrical modular receptacle in order to configure the modular electrical outlet relative to line, neutral and ground conductors.

What is needed in the art is a modular electrical receptacle, which can be easily reconfigured without disassembling the receptacle.

### SUMMARY OF THE INVENTION

The present invention provides a selectable receptacle including a housing, at least one plug-in connector and a faceplate having parallel blade openings.

The invention comprises, in one form thereof, a modular electrical receptacle including a housing, a faceplate being either integral with or attached to the housing, the faceplate having at least two blade openings. The receptacle also including a plurality of line conductors disposed at least partially within the housing, at least one neutral conductor positioned in the housing, at least one neutral conductor having a socket located proximate to at least one of the two blade openings and at least one selector switch electrically connected to at least one of the plurality of line conductors.

An advantage of the present invention is that a selectable receptacle is easily reconfigured by the use of a switch.

Another advantage is that a selecting switch is on the backside of the receptacle thereby inhibiting office personnel from changing the configuration of the selectable receptacle.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of an embodiment of a selectable electrical receptacle of the present invention installed in a modular wall panel;

FIG. 2 is a perspective view of the selectable electrical receptacle shown in FIG. 1;

FIG. 3 is a sectional view taken along line 3-3 of the selectable electrical receptacle of FIGS. 1 and 2;

FIG. 4 is a perspective view of a line conductor of the selectable electrical receptacle that is shown in FIG. 3;

FIG. 5 is a perspective view of the switched line conductor of the selectable electrical receptacle that is shown in FIG. 3;

FIG. 6 is an inside view of the back cover of the selectable electrical receptacle of FIGS. 1-3; and

FIG. 7 is an outside view of the back cover of the selectable receptacle shown in FIG. 6.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

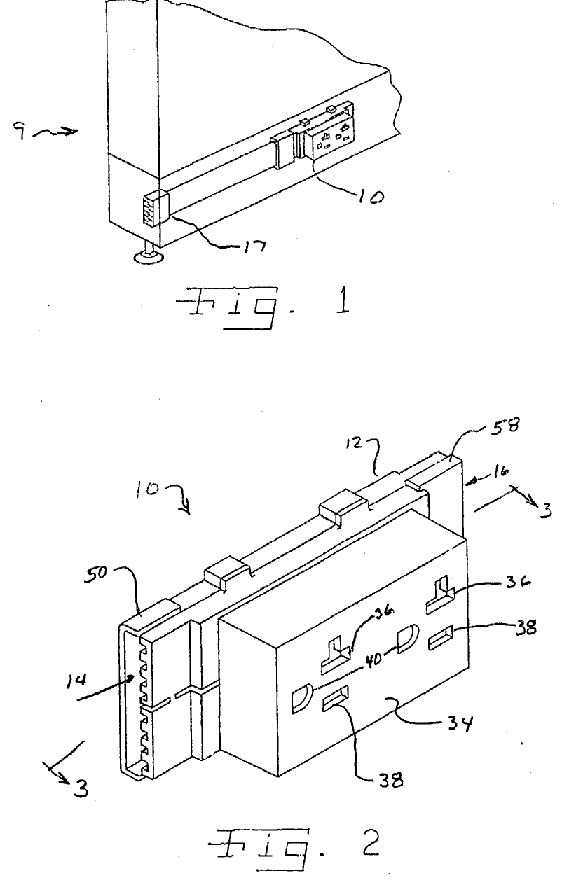

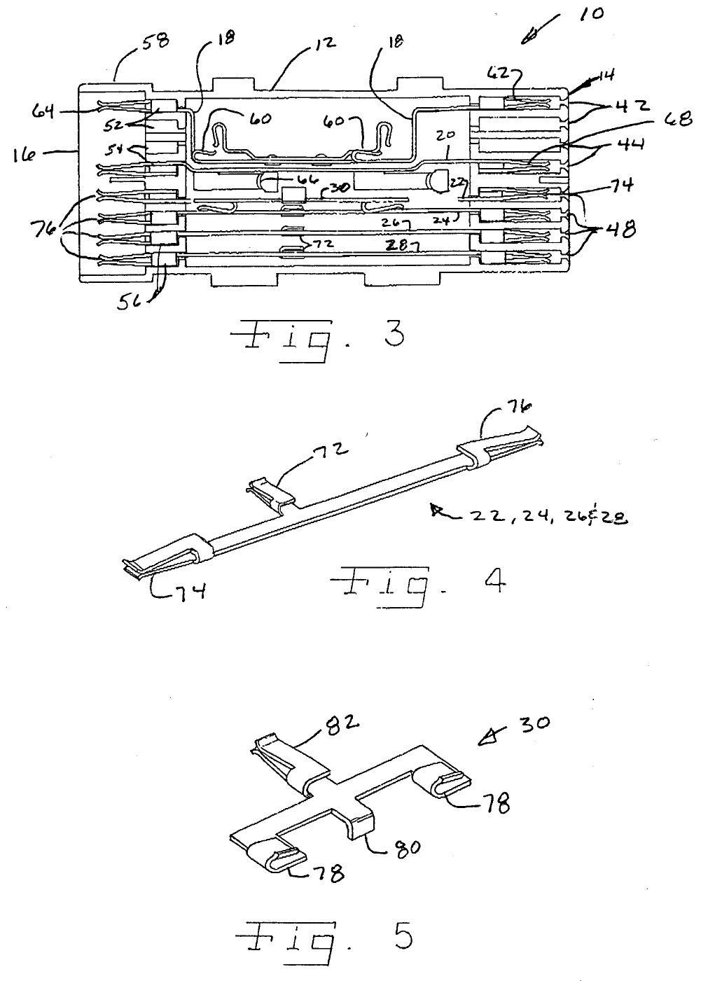

Referring now to the drawings, and more particularly to FIGS. 1-3 and 6, there is shown an embodiment of a selectable electrical receptacle 10 of the present invention installed in modular wall panel 9 and connected to wiring harness 17. Selectable receptacle 10 includes a housing 12, plug-in electrical connectors 14 and 16, neutral conductor 18, ground conductor 20, line conductors 22, 24, 26 and 28, switched line conductor 30 and line selector 32.

Housing 12 includes faceplate 34 and back cover 35. Faceplate 34 is attached to housing 12 or alternatively faceplate 34 can be integral with housing 12. Faceplate 34 has a pair of first parallel blade openings 36, a second pair of second blade openings 38 and ground blade openings 40. First blade openings 36 and second blade openings 38 are generally parallel to each other with first pair of blade openings 36 allowing access to switched line conductor 30 within housing 12. Second pair of blade openings 38 allow electrical access to ground conductor 20 within housing 12. Ground blade openings 40 are arranged to accommodate the ground blade of a standard electrical plug.

Plug-in electrical connector 14 has openings 42, 44 and 48, and plug-in electrical connector 16 has openings 52, 54 and 56. Openings 42 and 52 accommodate ends of neutral conductor 18; openings 44 and 54 accommodate ends of ground conductor 20; and likewise openings 48 and 56 accommodate ends of line conductors 22, 24, 26 and 28.

Neutral conductor 18 includes two parallel blade sockets 60, a first electrical contact 62 and a second electrical contact 64. Parallel blade sockets 60 are disposed to accommodate a neutral blade from an electrical plug that would enter through one of first blade openings 36 on faceplate 34. First electrical contact 62 is disposed within opening 42 and second electrical contact 64 is disposed within opening 52.

Ground conductor 20 includes two ground blade sockets 66 disposed and oriented towards ground blade opening 40 to accommodate a ground blade from a typical electrical plug. First electrical contact 68 is disposed at least partially within opening 44 and second electrical contact 70 is at least partially disposed within opening 54. The arrangement of ground conductor 20 in openings 44 and 54 allow for electrical conduction between plug-in electrical connector 14 and plug-in electrical connector 16.

Now, additionally referring to FIG. 4, there is shown line conductors 22, 24, 26 and 28 each having a switch contact 72, a first electrical contact 74 and a second electrical contact 76. First and second electrical contacts 74 and 76 are, respectively, arranged in corresponding openings 48 and 56. This arrangement allows electrical conduction of line current from plug-in electrical connector 14 through housing 12 to plug-in electrical connector 16. Switch contact 72 interfaces with line selector 32 to select electrical current from one of line conductors 22, 24, 26 and 28 and route the selected current to switched line conductor 30.

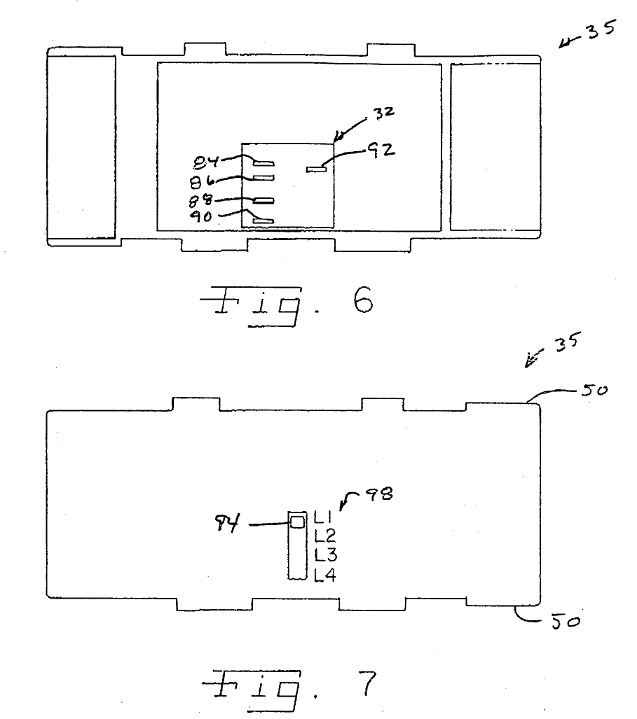

Now, additionally referring to FIG. 5, there is shown switched line conductor 30 including two blade sockets 78, retaining portion 80 and switch contact 82. Blade sockets 78 are arranged proximate to the pair of second blade openings 38 to provide electrical connection from the line circuit to a standard electrical plug. Retaining portion 80 interconnects with a portion of housing 12 to retain switched line conductor 30 and thereby position switched line conductor 30 within housing 12. Switched contact 82 electrically connects blade sockets 78 with line selector 32.

Now, additionally referring to FIGS. 6 and 7 there is shown back cover 35 with line selector 32 mounted therein. Line selector 32 includes line conductor connections 84, 86, 88 and 90; selected line output 92; four-position electrical switch 94 and legend 98. Line conductor connections 84, 86, 88 and 90, respectively, electrically connect with switch contact 72 of each line connector 22, 24, 26 and 28. Selected line output 92 is oriented to electrically connect with switch contact 82 of switched line conductor 30.

Four-position electrical switch 94 operates in a break before make capacity and it electrically connects one of line conductors 22, 24, 26 or 28 with switched line conductor 30 thereby allowing an operator to select one of the four line circuits to be electrically connected to switched line conductor 30. Four-position switch 94 is illustrated as a slide switch although another type of multiple-pole switch may be utilized, such as a rotary switch. Legend 98, on the backside of back cover 35, is a visual indication as to which line conductor 22, 24, 26 or 28, switched line conductor 30 is connected.

Flanges 50 and 58, respectively associated with, plug-in connectors 16 and 14, coact to key plug-in connectors 14 and 16 with another selectable receptacle 10 or a mating electrical connector from wiring harness 17. The keyed connection ensures that the connection preserves the polarities of the circuits. Plug-in electrical connectors 14 and 16 may be separate from or integral with housing 12 and back cover 35.

To configure selectable receptacle 10 such that one of line conductors 22, 24, 26 or 28 is electrically connected to switched line conductor 30, prior to inclusion in modular wall panel 9, an installer moves four-position switch 94 to the appropriate position according to legend 98. The installer then electrically interfaces selectable receptacle 10 with wiring harness 17 or another selectable receptacle 10 and installs the electrical assembly within modular wall panel system 9. Maintenance personnel may easily reconfigure selectable receptacle 10 by gaining access to the backside of selectable receptacle 10 and sliding switch 96 of line selector 32 between one of the four line circuit selections. The selection of a different line circuit can be accomplished whether or not receptacle 10 is electrically active.

Even though four line circuit selections have been shown in the accompanying drawings and described hereinabove more than or fewer than four line configurations may be provided. Alternatively, neutral and or ground conductors can likewise be configured to have separate selectable switches to easily configure multiple ground or neutral circuits as well. Also, line selector 32 may be a multiple-pole/multiple-throw switch, which selects predetermined sets of line, neutral and/or ground circuits.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A modular electrical receptacle, comprising:
a housing;
a faceplate being one of integral with and attached to said housing, said faceplate having at least two blade openings;
a plurality of line conductors disposed at least partially within said housing;
at least one neutral conductor positioned in said housing, at least one said neutral conductor having a socket located proximate at least one of said at least two blade openings; and
at least one selector switch electrically connected to at least one of said plurality of line conductors.

2. The modular electrical receptacle of claim 1, further comprising at least one switched line conductor having a socket located proximate at least one of said at least two blade openings, at least one said switched line conductor electrically connected to at least one said selector switch.

3. The modular electrical receptacle of claim 2, wherein at least one said selector switch selectively electrically connects one of said plurality of line conductors to one said switched line conductor.

4. The modular electrical receptacle of claim 2, wherein said at least one selector switch is configured to selectively electrically connect one of said plurality of line conductors to one said switched line conductor while said one line conductor is electrically active.

5. The modular electrical receptacle of claim 1, wherein said faceplate is located on a side of said housing and said at least one selector switch is positioned on an opposite side of said housing.

6. The modular electrical receptacle of claim 1, wherein said at least one selector switch is a break before make switch.

7. The modular electrical receptacle of claim 1, wherein said at least one selector switch is one of a sliding switch and a rotary switch.

8. The modular electrical receptacle of claim 1, wherein said at least one selector switch is electrically connected to each of said plurality of line conductors.

9. The modular electrical receptacle of claim 1, further comprising a plurality of electrical connectors being one of integral with and connected to said housing.

10. The modular electrical receptacle of claim 9, wherein said plurality of line conductors each have a first end and a second end, said plurality of electrical connectors including a first connector and a second connector, said first end of at least one said plurality of line conductors at least partially disposed within said first connector and said second end of at least one said plurality of line conductors at least partially disposed within said second connector.

11. The modular electrical receptacle of claim 1, further comprising at least one ground conductor positioned in said housing, at least one said ground conductor having a socket located proximate at least one said at least two blade openings.

12. An electrical system assembly, comprising:
at least one interconnecting wire harness; and
a modular electrical receptacle electrically connected to at least one said interconnecting wire harness, said modular electrical receptacle including:
a housing;
a faceplate being one of integral with and attached to said housing, said faceplate having at least two blade openings;
a plurality of line conductors disposed at least partially within said housing;
at least one neutral conductor positioned in said housing, at least one said neutral conductor having a socket located proximate at least one said at least two blade openings; and
at least one selector switch electrically connected to at least one of said plurality of line conductors.

13. The electrical system assembly of claim 12, wherein said modular electrical receptacle further comprises at least one switched line conductor having a socket located proximate at least one of said at least two blade openings, at least one said switched line conductor electrically connected to at least one said selector switch.

14. The electrical system assembly of claim 13, wherein at least one said selector switch selectively electrically connects one of said plurality of line conductors to one said switched line conductor.

15. The electrical system assembly of claim 13, wherein said at least one selector switch is configured to selectively electrically connect one of said plurality of line conductors to one said switched line conductor while said one line conductor is electrically active.

16. The electrical system assembly of claim 12, wherein said faceplate is located on a side of said housing and said at least one selector switch is positioned on an opposite side of said housing.

17. The electrical system assembly of claim 12, wherein said at least one selector switch is one of a sliding switch and a rotary switch.

18. The electrical system assembly of claim 12, wherein said at least one selector switch is electrically connected to each of said plurality of line conductors.

19. The electrical system assembly of claim 12, wherein said modular electrical receptacle further comprises a plurality of electrical connectors being one of integral with and connected to said housing.

20. A modular wall panel system, comprising:
a modular wall panel; and
an electrical system assembly disposed at least partially within at least one said modular wall panel, said electrical system assembly including:
at least one interconnecting wire harness; and
a modular electrical receptacle electrically connected to at least one said interconnecting wire harness, said modular electrical receptacle including:
a housing;
a faceplate being one of integral with and attached to said housing, said faceplate having at least two blade openings;
a plurality of line conductors disposed at least partially within said housing;
at least one neutral conductor positioned in said housing, at least one said neutral conductor having a socket located proximate at least one said at least two blade openings; and
at least one selector switch electrically connected to at least one of said plurality of line conductors.

21. The system of claim 20, wherein said modular electrical receptacle further comprises at least one switched line conductor having a socket located proximate at least one of said at least two blade openings, at least one said switched line conductor electrically connected to at least one said selector switch.

22. The system of claim 21, wherein at least one said selector switch selectively electrically connects one of said plurality of line conductors to one said switched line conductor.

23. The system of claim 21, wherein said at least one selector switch is configured to selectively electrically connect one of said plurality of line conductors to one said switched line conductor while said one line conductor is electrically active.

24. The system of claim 20, wherein said faceplate is located on a side of said housing and said at least one selector switch is positioned on an opposite side of said housing.

25. The system of claim 20, wherein said at least one selector switch is one of a sliding switch and a rotary switch.

26. The system of claim 20, wherein said at least one selector switch is electrically connected to each of said plurality of line conductors.

27. The system of claim 20, wherein said modular electrical receptacle further comprises a plurality of electrical connectors being one of integral with and connected to said housing.
